(19) United States
(12) Patent Application Publication
(10) Pub. No.: US 2015/0378646 A1
(43) Pub. Date: Dec. 31, 2015

(54) RECOMMENDING PRINTERS AND SUGGESTING ACTIONS FOR TAILORED AND EFFICIENT FULFILLMENT OF PRINT REQUESTS

(71) Applicant: International Business Machines Corporation, Armonk, NY (US)

(72) Inventors: Martina James, Crows Nest (AU); Daniel C. Krook, Fairfield, CT (US); Leena C. Mathew, Airmont, NY (US); Thiago V. Munhoz, Sao Paolo (BR)

(21) Appl. No.: 14/314,152

(22) Filed: Jun. 25, 2014

(51) Int. Cl. G06F 3/12

(52) U.S. Cl. CPC G06F 3/126; G06F 3/1211; G06F 3/1253

(57) ABSTRACT

A method for recommending printers and suggesting actions for tailored and efficient fulfillment of print requests is provided. The method provides: receiving, by a printer service, a request to generate a print job. The request comprises a proximity to a requestor, and a plurality of printer properties. The printers in a collection of potential printers are matched for a proximity to the requestor and the plurality of printer properties. A list of top matching available printers is created, based on the proximity to the requestor and the plurality of printer properties. A list of unavailable and incompatible printers is created, based on the matching of the proximity to the requestor. Both lists are displayed. The print job is sent to the printer that the requestor selects.

### FIELD OF THE INVENTION

The present disclosure relates generally to the field of digital data processing, and more specifically to locating a printer based on its capabilities and those of its users.

### BACKGROUND

Printers are examples of typical computer peripherals that are installed in offices, universities, homes, and other venues. These peripherals are assigned a unique identifier, such as a name or Internet Protocol (IP) address, as part of the process of connecting them to a network. A user typically specifies the unique identifier as the destination when sending work to a printer. In a mobile environment, a user may need to print from multiple office locations, customer locations, or from a hotel while traveling. While the user may maintain lists of accessible networked peripherals on his computer or mobile device, selecting a device from a large list, or keeping the large list updated may become difficult, as is locating a suitable nearby printer when traveling to a new location.

### BRIEF SUMMARY

Among other things, a method for recommending printers and suggesting actions for tailored and efficient fulfillment of print requests is provided. The method comprises: receiving, by a printer service, a request to generate a print job, the request comprising a proximity to a requestor, and a plurality of printer properties. The method further comprises: matching the proximity to the requestor and the plurality of printer properties to printers in a collection of potential printers; creating a list of top matching available printers, based on the matching of the proximity to the requestor and the plurality of printer properties; creating a list of unavailable and incompatible printers, based on the matching of the proximity to the requestor; displaying the list of top matching printers and the list of unavailable and incompatible printers to the requestor; and sending the print job to a printer based on the requestor selecting the printer.

In another embodiment, a computer program product for recommending printers and suggesting actions for tailored and efficient fulfillment of print requests is provided and comprises: a computer readable storage medium readable by a processing circuit and storing instructions for execution by the processing circuit for performing a method comprising: receiving, by a printer service, a request to generate a print job, the request comprising a proximity to a requestor, and a plurality of printer properties. The computer program product further comprises: matching the proximity to the requestor and the plurality of printer properties to printers in a collection of potential printers; creating a list of top matching available printers, based on the matching of the proximity to the requestor and the plurality of printer properties; creating a list of unavailable and incompatible printers, based on the matching of the proximity to the requestor; displaying the list of top matching printers and the list of unavailable and incompatible printers to the requestor; and sending the print job to a printer based on the requestor selecting the printer.

In another embodiment, a computer system for recommending printers and suggesting actions for tailored and efficient fulfillment of print requests is provided, comprising one or more processors, one or more computer-readable storage devices, and a plurality of program instructions stored on at least one of the one or more storage devices for execution by at least one of the one or more processors is provided. The plurality of program instruction comprise: a computer readable storage medium readable by a processing circuit and storing instructions for execution by the processing circuit for performing a method comprising: receiving, by a printer service, a request to generate a print job, the request comprising a proximity to a requestor, and a plurality of printer properties. The computer system further comprises: matching the proximity to the requestor and the plurality of printer properties to printers in a collection of potential printers; creating a list of top matching available printers, based on the matching of the proximity to the requestor and the plurality of printer properties; creating a list of unavailable and incompatible printers, based on the matching of the proximity to the requestor; displaying the list of top matching printers and the list of unavailable and incompatible printers to the requestor; and sending the print job to a printer based on the requestor selecting the printer.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to one embodiment;

FIG. 2 is a flowchart of an exemplary embodiment of the disclosure;

FIGS. 3-4 are exemplary outputs of the method of FIG. 2; and

FIG. 5 is a schematic block diagram of internal and external components of the hardware and software computer environment according to an embodiment of the method of FIG. 2.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

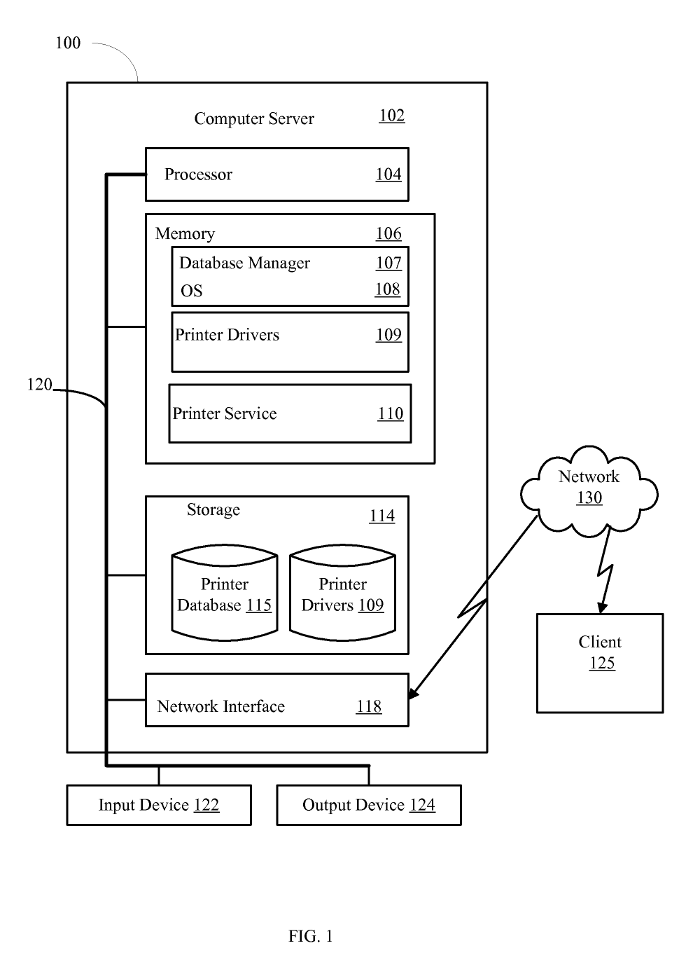

Embodiments of the present invention will now be described with reference to the figures. FIGS. 1-5 depict an exemplary implementation for locating a printer based on its capabilities and those of its users.

FIG. 1 illustrates a system 100 according to an exemplary embodiment. The networked system 100 includes a computer server 102 hosting a printer service 110 that suggests the nearest available printer with the capabilities specified by a print request. The computer server 102 may also be connected to other computers and servers via a network 130. The network 130 may include connections, such as wire, wireless communication links, or fiber optic cables.

The computer server 102 generally includes a processor 104 connected via a bus 120 to a memory 106, a network interface device 118, a storage 114, an input device 122, and an output device 124. The computer server 102 is generally under the control of an operating system (OS) 108, such as for example Linux. However, any operating system supporting the functions disclosed herein may be used. The processor 104 is included to be representative of a single CPU, multiple CPUs, a single CPU having multiple processing cores, and the like. Similarly, the memory 106 may be a random access memory. While the memory 106 is shown as a single identity, it should be understood that the memory 106 may comprise a plurality of modules, and that the memory 106 may exist at multiple levels, from high speed registers and caches to lower speed but larger formats. The network interface device 118 may be any type of network communications device allowing the computer server 102 to communicate with other computers via the network 130.

The storage 114 may be a combination of fixed persistent optical and/or solid state storage devices. The memory 106 and the storage 114 may be part of one virtual address space spanning multiple primary and secondary storage devices.

The input device 122 may be any device for providing input to the computer server 102. For example, a keyboard and/or a mouse may be used. The output device 124 may be any device for providing output to a user of the computer server 102. Although shown separately from the input device 122, the output device 124 and input device 122 may be combined, as in a display screen with an integrated touch-screen.

As shown, the memory 106 of the computer server 102 includes a printer service 110, which may comprise one or more software modules configured to manage one or more components associated with the printer service 110. For example, the printer drivers 109 may be one component that is managed by the printer service 110. One or more printer databases 115, under the management of a database manager 107, may provide persistent storage for configuration and status information related to the printers. Such configuration and status information may be accessed and processed by the printer service 110 via, for example, the database manager 107, in order to select one or more printers matching a user-defined printer profile. Each printer may be associated with a printer driver, which enables the printer service 110, working in cooperation with the OS 108, to deliver the capabilities of the printer's hardware. The printer drivers 109 may be stored in a library within the storage 114 of the computer server 102. For efficient performance, the printer drivers 109 may be loaded into memory 106.

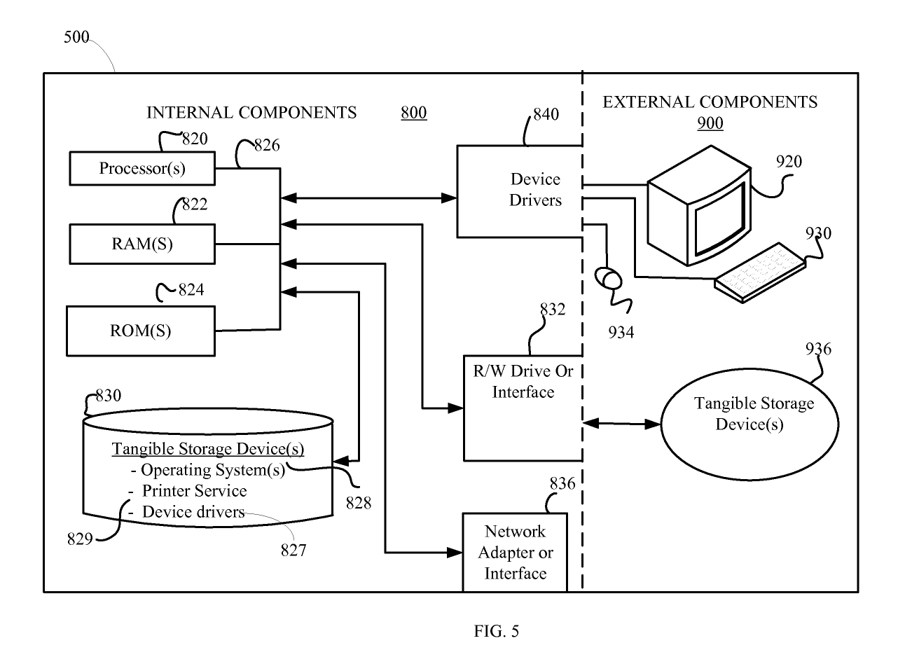

The client 125 may be configured as a workstation, tablet, smart phone, or other device that may connect to the computer server 102 over the network 130. As will be discussed with reference to FIG. 5, the computer server 102 and the computer hosting the client 125 may include internal components 800 and external components 900.

The particular description in FIG. 1 is for illustrative purposes only; it should be understood that the invention is not limited to specific described embodiments, and any combination is contemplated to implement and practice the invention.

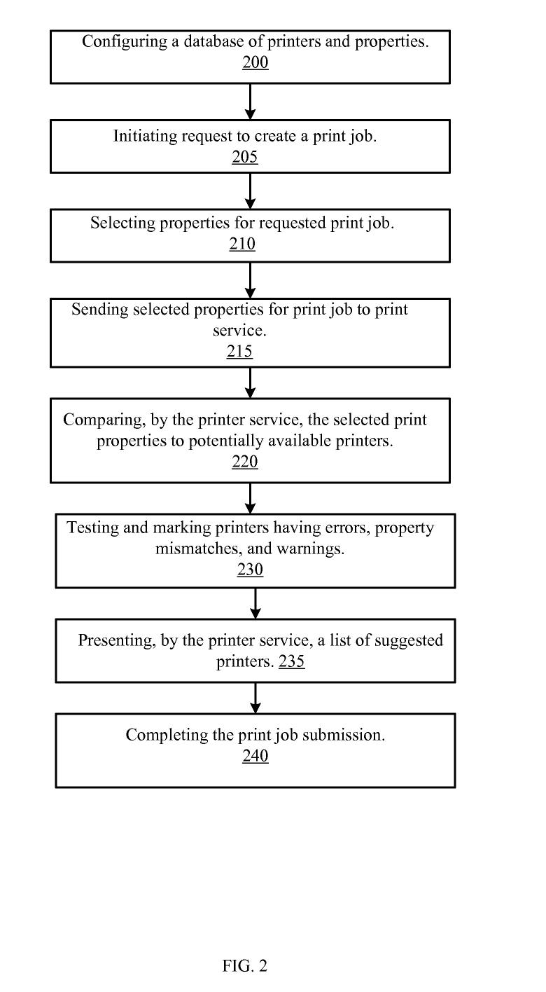

Referring now to FIG. 2, an exemplary embodiment of locating a printer based on its capabilities is illustrated. Printer service 110 (FIG. 1) may interact with and manage, at least in part, the process of FIG. 2. As used hereinafter, a printer also includes a printer having other functionalities, such as faxing and scanning. As such, a print request, or print job, also includes a request to scan or fax. In order for the printer service 110 (FIG. 1) to effectively evaluate and match a destination for a print request, a database of printers and their properties is configured, 200, using any data management architecture suitable for easy retrieval of a printer based on one or more of its properties. The properties that may be collected for each printer in the printer database 115 (FIG. 1) may include: the name and manufacturer; physical location of the printer; printer properties, such as paper sizes available, duplex, stapling; printer capabilities, such as whether the printer is in a secured area, the printer's ability to fax and scan; printer status, such as ready, offline, error; inventory of consumables, such as toner and paper; error condition, such as paper jam, out of paper or toner; the printer's performance capabilities, such as pages per minute (ppm); and the length of the printer queue. Additionally, where available, characteristics such as cost per print may be tracked for some commercial providers, such as FedEx and HP public printers. As may be appreciated by those skilled in data management, there are many options for entering the printer properties data. For example, printer properties data may be manually or programmatically entered using Structured Query Language (SQL), programming, script language, submitted via Application Program Interfaces (APIs), network discovery, or via web services. Additional methods, such as discovery based on print protocols using software robots (bots), enable the printer service 110 (FIG. 1) to act as provisioning a self-learning database, employing all known methods of printer discovery. In addition, the printer service 110 (FIG. 1) may directly query networked printers to discover their properties. The printer may also provide a driver software module that the printer service 110 (FIG. 1) may store in a library of printer drivers 109 (FIG. 1). A printer's driver enables a computer operating system and client applications to access and control the printer's hardware functionality. By centralizing a library of printer drivers 109 (FIG. 1) within the printer service 110 (FIG. 1), the user is relieved of the task of maintaining and updating a plurality of printer drivers on each mobile or computing device the user has.

Although the printer database 115 (FIG. 1) is shown collocated with the printer service 110 (FIG. 1) and the printer drivers 109 (FIG. 1) on the computer server 102, it may be understood that these components are location independent. For example, the system 100 (FIG. 1) may be implemented as a cloud-based service, for example using the software as a service (SaaS) model. In the SaaS model, users are provided access to application software and databases, such as the printer service 110 (FIG. 1) and the printer database 115 (FIG. 1). Cloud service providers manage the infrastructure and platforms that host the application. In the SaaS model, cloud providers install and operate application software in the cloud and cloud users access the software from cloud clients. This model simplifies maintenance and support, and enhances scalability and availability of the application, since the cloud service provider may add underlying servers and other infrastructure as needed to meet demand. However, the printer service 110 (FIG. 1) may be implemented on other cloud-based architectures, as well. For example, in one embodiment, using an infrastructure as a service (IaaS) model, the cloud service provider may provide the physical or virtual computers onto which the providers of the printer service 110 (FIG. 1) install their operating system images, printer service 110 (FIG. 1) modules, and databases of printer properties and printer drivers. In another embodiment, using the platform as a service (PaaS), the cloud service provider may deliver a computing platform, comprising an operating system, programming development environment, and a database and web server. The printer service 110 (FIG. 1) may be implemented on the platform, without the cost and complexity of maintaining the underlying hardware and software layers.

A user may initiate a request to create a print job, 205, using, for example, a computer, laptop, tablet, smart phone, or similar mobile device. In one embodiment, the user may interact with the printer service 110 (FIG. 1) through an application that may be installed on the computer or mobile device for creating the print request. Alternatively, the user may interact with the printer service 110 (FIG. 1) through a graphical user interface (GUI) on a web server that may be located, for example, on the computer server 102 (FIG. 1), or on another computer that is connected to the computer server 102 (FIG. 1) by a network 130 (FIG. 1). In another embodiment, the printer service 110 (FIG. 1) may publish an API. A provider of an application, for example, a spreadsheet application, word processor, desktop publishing application, or other similar content authoring tool, may create a customized module within the provider's application, using the API, through which a user may create print requests. In a further embodiment, the printer service 110 (FIG. 1) may provide a command line interface through which the user may issue keyword commands and options to create and modify print requests. The command line commands and keywords may additionally be embedded in scripts, such as PERL, or called from program code, such as C or C++.

The user may select desired properties for the print request, 210, such as paper size; color or black and white; duplex; and secure printing. Where the user accesses the printer service 110 (FIG. 1) using a command line, the desired properties for the print request may be entered as keywords or options to the print command. In a GUI environment, the desired properties may be selected from drop-down menus, radio buttons, and the like. The selected properties for the print request are sent to the printer service 110 (FIG. 1), 215, along with the user's security credentials. In some embodiments, security credentials may not be required. However in most cases authentication will be required for the user to have access to see the widest variety of printer choices. Details about the Wi-fi or LAN from which the user is making the request may also be sent, as well as geographic location data, which may be queried from the user's device using well-known APIs, such as geolocation. In another embodiment, the user may create a profile of keywords and options for each one of frequently used printers. The user may optionally choose to see only printers from this group of profiles, or to have printers with associated profiles sort to the top of the suggested list of compatible printers.

Upon receiving the selected print properties, the printer service 110 (FIG. 1) compares the received print properties to the printers that are potentially available to the user, 220. The printer service 110 (FIG. 1) tests and marks printers having errors, property mismatches, and warnings, 230. For example, a property mismatch is recognized when the printer is not equipped with the requested property, such as duplex printing. Printers having an error condition, such as paper jam, and printers that are offline are also marked. The printer service 110 (FIG. 1) also tests and marks with a warning, printers with such conditions as being in a busy state. However, non-administered printers, such as home printers, may be unable to provide complete status and may instead report the unknown properties as warnings. In another embodiment, the printer service 110 (FIG. 1) may be configured to periodically poll and update the status of configured printers in the printer database 115 (FIG. 1).

The printer service 110 (FIG. 1) presents the user with a suggested list of nearest top matching compatible printers, 235. In some environments, for example within a corporate network, it may be appreciated that the list of compatible printers may be unwieldy. To ensure that a useful and meaningful list of compatible printers is presented, the user may configure a maximum number of printers to return, such as “10”. A list of incompatible or unavailable printers is also presented, along with a suggestion on how to make the printer compatible for the print job. If the suggestion is to alter the print job, for example to “Switch to black-and-white print to use this printer”, the user may be presented with an actionable interface (button, link or such) through which the print job properties can be immediately altered. In this case, the user may make the simple alteration and complete the print job submission, 240. In another example, indicators may be available for other conditions causing a printer to be unavailable, such as a paper jam or being out of paper. In this case, the user may determine whether it is more convenient to clear the error condition, i.e., reload the paper, or to select an alternate printer. After clearing the error condition, or selecting an alternate printer, the print job submission is completed, 240.

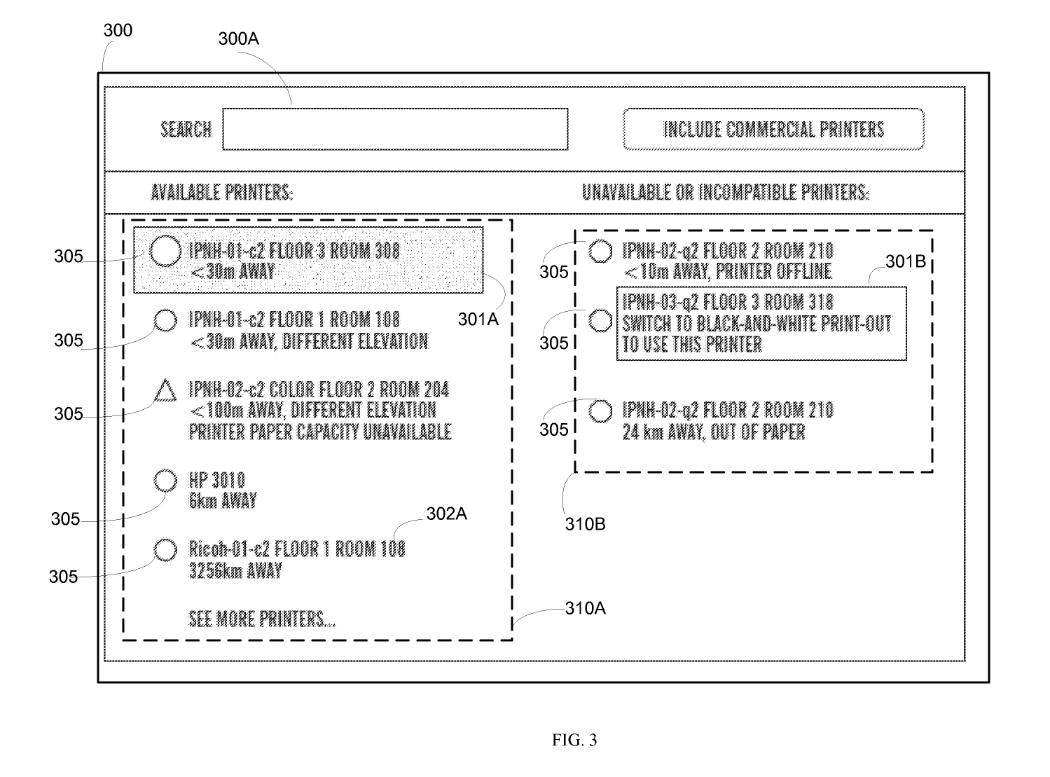

As shown in FIG. 3, a list of suggested nearest printers may be sorted by proximity to the user's location, as determined by the geolocation and network identification data that was sent to the printer service 110 (FIG. 1) with the user's initial request. As depicted in FIG. 3, an exemplary GUI 300 may provide a list of available printers 310A and a list of unavailable or incompatible printers 310B. The list of available printers 310A may include those that include the user-defined properties for a particular print job. The list of unavailable or incompatible printers 310B may include those that either do not include the user-defined properties for a particular print job, or fail to be available (e.g., paper jam, in use, etc.). However, the list of unavailable or incompatible printers 310B may become available or compatible, and thus, reassigned to list 310A.

For example, list entry 301A indicates a compatible printer (i.e., printer at: Floor 3 Room 308) that is closest to the users geographical location, while list entry 302A indicates a compatible printer (i.e., printer at: Floor 1 Room 108) that is farthest to the users geographical location. However, the list may alternatively be sorted by other fields, such as printer type, a particular location, or a building. In addition to showing the proximity of the printer to the user, the printer service 110 (FIG. 1) may indicate that choosing another option, or addressing an error condition may make a particular printer compatible. For example, the printer service 110 (FIG. 1) may suggest that if the user takes the action of changing a print property from color to black and white, the printer with list entry 301B may become compatible. Upon making this change, the printer associated with list entry 301B may be reassigned from the unavailable or incompatible printer list entry 310B to the available list entry 310A. The status indicators 305 may be enhanced with color indicators, such as red for error conditions, yellow for printers having warnings, and green for printers having neither errors nor warnings. To assist the user in visually scanning the displayed list, the status indicators 305 may be associated with universally recognized symbols. For example, a red octagonal indicator may correspond to a severe error condition. Similarly, a yellow triangle indicator may correspond to a warning condition. Since there may be more than one page of suggested printers displayed, the user may filter the results by typing a particular entry or a wild card qualified entry in a search box 300A. An additional option, shown in FIG. 3, allows the user to include commercial printers, such as FedEx or HP public printers, in the suggested list of printers.

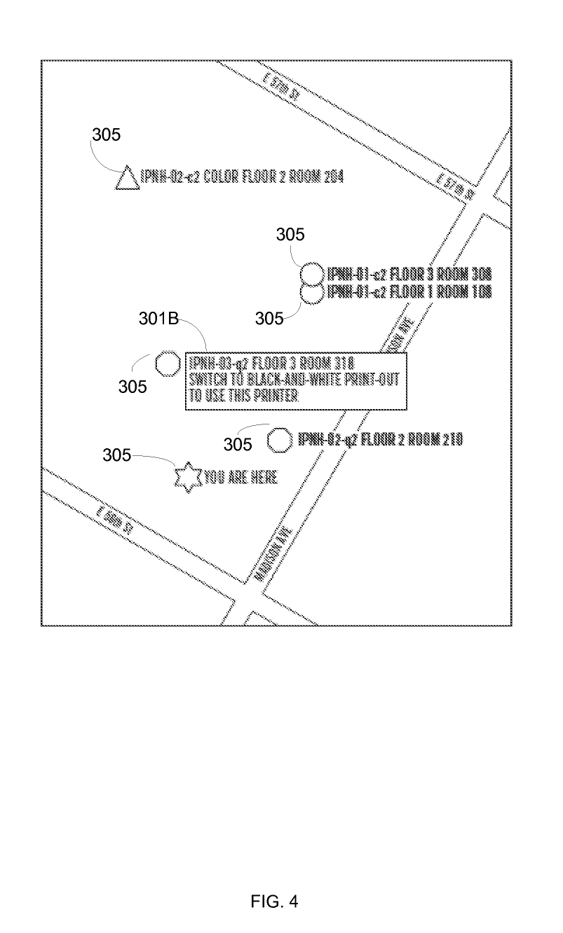

As shown in FIG. 4, the location information corresponding to each printer may be included in a geographic information system (GIS) created map. FIG. 4 displays the printers listed in tabular form in FIG. 3 as a geographic proximity map. For example, the printer corresponding to list entry 301B of FIG. 3 is mapped or converted to depict the geographic location of the printer corresponding to list entry 301B (FIG. 3). The message associated with the list entry 301B as shown in FIG. 3 is also shown in the list entry 301B of FIG. 4. As in FIG. 3, the status indicators 305 may be enhanced with color indicators, such as red for error conditions, yellow for printers having warnings, and green for printers having neither errors nor warnings. The status indicators 305 may be associated with universally recognized symbols. For example, a red octagonal indicator may correspond to a severe error condition. Similarly, a yellow triangle indicator may correspond to a warning condition. An additional status indicator 305 may be provided to show the requestor's geographical location (i.e., you are here).

Referring now to FIG. 5, computing device 500 may include respective sets of internal components 800 and external components 900 that together may provide an environment for a software application, such as a printer service. Each of the sets of internal components 800 includes one or more processors 820; one or more computer-readable RAMs 822; one or more computer-readable ROMs 824 on one or more buses 826; one or more operating systems 828; one or more software applications (e.g., printer service modules 829 and device drivers 827) executing the method of FIG. 2; and one or more computer-readable tangible storage devices 830. The one or more operating systems 828, printer service modules 829, and device drivers 827 are stored on one or more of the respective computer-readable tangible storage devices 830 for execution by one or more of the respective processors 820 via one or more of the respective RAMs 822 (which typically include cache memory). In the embodiment illustrated in FIG. 5, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800 also includes a R/W drive or interface 832 to read from and write to one or more computer-readable tangible storage devices 936 such as a CD-ROM, DVD, SSD, memory stick, magnetic tape, magnetic disk, optical disk or semiconductor storage device.

Each set of internal components 800 may also include network adapters (or switch port cards) or interfaces 836 such as a TCP/IP adapter cards, wireless WI-FI interface cards, or 3G or 4G wireless interface cards or other wired or wireless communication links. The grid management modules 829, and operating system 828 that are associated with computing device 500, can be downloaded to computing device 500 from an external computer (e.g., server) via a network (for example, the Internet, a local area network, or other wide area network) and respective network adapters or interfaces 836. From the network adapters (or switch port adapters) or interfaces 836 and operating system 828 associated with computing device 500 are loaded into the respective hard drive 830 and network adapter 836. The network may comprise copper wires, optical fibers, wireless transmission, routers, firewalls, switches, gateway computers and/or edge servers.

Each of the sets of external components 900 can include a computer display monitor 920, a keyboard 930, and a computer mouse 934. External components 900 can also include touch screens, virtual keyboards, touch pads, pointing devices, and other human interface devices. Each of the sets of internal components 800 also includes device drivers 840 to interface to computer display monitor 920, keyboard 930 and computer mouse 934. The device drivers 840, R/W drive or interface 832 and network adapter or interface 836 comprise hardware and software (stored in storage device 830 and/or ROM 824).

Various embodiments of the invention may be implemented in a data processing system suitable for storing and/or executing program code that includes at least one processor coupled directly or indirectly to memory elements through a system bus. The memory elements include, for instance, local memory employed during actual execution of the program code, bulk storage, and cache memory which provide temporary storage of at least some program code in order to reduce the number of times code must be retrieved from bulk storage during execution.

Input/Output or I/O devices (including, but not limited to, keyboards, displays, pointing devices, DASD, tape, CDs, DVDs, thumb drives and other memory media, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the available types of network adapters.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Although preferred embodiments have been depicted and described in detail herein, it will be apparent to those skilled in the relevant art that various modifications, additions, substitutions and the like can be made without departing from the spirit of the disclosure, and these are, therefore, considered to be within the scope of the disclosure, as defined in the following claims.

1. A method for recommending printers and suggesting actions for tailored and efficient fulfillment of print requests comprising:
receiving, by a printer service, a request to generate a print job, the request comprising a requestor's geographic location data, one or more printer profiles, and a plurality of printer properties including paper size, duplex, color, black and white, and the requestor's security credentials when the print request includes secure printing;
creating a list of top matching available, unavailable, and incompatible printers from a database of potential printers, wherein the list is based on matching one or more printers from the database of potential printers to the requestor's geographic location data, the plurality of printer properties, the one or more printer profiles, and the requestor's security credentials when the print request includes secure printing;
displaying the created list of top matching available, unavailable and incompatible printers, wherein the displayed list includes:
an input field for filtering the displayed list and wherein the input field accepts a keyword qualified entry for filtering and a wild card qualified entry, wherein the wild card is a substring of the keyword qualified entry; and
an option to display commercial provider printers; and
sending the print job to a printer selected from the displayed list.

2. The method of claim 1, wherein the displayed list of top matching available, unavailable and incompatible printers further comprises:
a printer name;
a description of the printer geographical location relative to the requestor;
a symbol corresponding to a status of the printer;
a color indicator corresponding to the status; and
a map showing the described geographical location.

3. The method of claim 2, wherein the list of unavailable and incompatible printers further comprises:
a text comment, wherein the text comment is a suggested action for changing the status of the printer to available and compatible.

4. (canceled)

5. The method of claim 1, wherein an unavailable and incompatible printer associated with the list of unavailable and incompatible printers is reassigned to the list of top matching available printers, based on the requestor altering one or more printer properties.

6. The method of claim 1, wherein the printer service comprises:
a graphical user interface (GUI);
print protocols using software robots (bots);
a database manager;
one or more printer databases, wherein the one or more printer databases include configuration and status information related to the printers;
a library of printer drivers;
a command line; and
an application program interface (API).

7. A program product for recommending printers and suggesting actions for tailored and efficient fulfillment of print requests comprising:
a non-transitory computer readable medium encoded with a program product and storing instructions for execution by the processing circuit for performing a method comprising:
receiving, by a printer service, a request to generate a print job, the request comprising a requestor's geographic location data, one or more printer profiles, and a plurality of printer properties including at least one of paper size, duplex, color, black and white, and the requestor's security credentials when the print request includes secure printing;
creating a list of top matching available, unavailable, and incompatible printers from a database of potential printers, wherein the list is based on matching one or more printers from the database of potential printers to the requestor's geographic location data, the plurality of printer properties, the one or more printer profiles, and the requestor's security credentials when the print request includes secure printing;
displaying the created list of top matching available, unavailable and incompatible printers, wherein the displayed list includes:
an input field for filtering the displayed list and wherein the input field accepts a keyword qualified entry for filtering and accepts a wild card qualified entry, wherein the wild card is a substring of the keyword qualified entry; and
an option to display commercial provider printers; and
sending the print job to a printer selected from the displayed list.

8. The computer program product of claim 7, wherein the displayed list of top matching available, unavailable and incompatible printers further comprises:
a printer name;
a description of the printer geographical location relative to the requestor;
a symbol corresponding to a status of the printer;
a color indicator corresponding to the status; and
a map showing the described geographical location.

9. The computer program product of claim 8, wherein the list of unavailable and incompatible printers further comprises:
a text comment, wherein the text comment is a suggested action for changing the status of the printer to available and compatible.

10. (canceled)

11. The program product of claim 7, wherein an unavailable and incompatible printer associated with the list of unavailable and incompatible printers is reassigned to the list of top matching available printers, based on the requestor altering one or more printer properties.

12. The computer program product of claim 7, wherein the printer service comprises:
a graphical user interface (GUI);
print protocols using software robots (bots);
a database manager;
one or more printer databases, wherein the one or more printer databases include configuration and status information related to the printers;
a library of printer drivers;
a command line; and
an application program interface (API).

13. The computer program product of claim 7, wherein the database of potential printers comprises:
a printer name and printer vendor name;
at least one printer property, comprising:
available paper sizes;
color printing;
duplex printing;
inventory of consumables;
a length of a printer queue;
a printer status;
a printer error condition;
cost per print for commercial providers;
ability to fax and scan;
ability to staple;
whether the printer is in a secured area;
an association of a printer to a network; and
printer performance; and
a library of printer drivers associated with the database of printers.

14. A computer system for recommending printers and suggesting actions for tailored and efficient fulfillment of print requests comprising:
one or more processors, one or more computer-readable memories, one or more computer-readable tangible storage devices, and program instructions stored on at least one of the one or more computer-readable tangible storage devices for execution by at least one of the one or more processors via at least one of the one or more memories, the program instructions comprising:
program instructions to receive, by a printer service, a request to generate a print job, the request comprising a requestor's geographic location data, one or more printer profiles, and a plurality of printer properties including paper size, duplex, color, black and white, and the requestor's security credentials when the request includes secure printing;
program instructions to create a list of top matching available, unavailable, and incompatible printers from a database of potential printers, wherein the list is based on matching one or more printers from the database of potential printers to the requestor's geographic location data, the plurality of printer properties, the one or more printer profiles, and the requestor's security credentials when the request includes secure printing;
program instructions to display the created list of top matching available, unavailable and incompatible printers, wherein the displayed list includes:
an input field for filtering the displayed list and wherein the input field accepts a keyword qualified entry for filtering and accepts a wild card qualified entry, wherein the wild card is a substring of the keyword qualified entry; and
an option to display commercial provider printers; and
program instructions to send the print job to a printer selected from the displayed list.

15. The computer system of claim 14, wherein the displayed list of top matching available, unavailable and incompatible printers further comprises:
a printer name;
a description of the printer geographical location relative to the requester;
a symbol corresponding to a status of the printer;
a color indicator corresponding to the status; and
a map showing the described geographical location.

16. The computer system of claim 15, wherein the list of unavailable and incompatible printers further comprises:
a text comment, wherein the text comment is a suggested action for changing the printer status to available and compatible.

17. (canceled)

18. The computer system of claim 14, wherein an unavailable and incompatible printer associated with the list of unavailable and incompatible printers is reassigned to the list of top matching available printers, based on the requestor altering one or more printer properties.

19. The computer system of claim 14, wherein the printer service comprises:
a graphical user interface (GUI);
print protocols using software robots (bots);
a database manager;
one or more printer databases, wherein the one or more printer databases include configuration and status information related to the printers;
a library of printer drivers;
a command line; and
an application program interface (API).

20. The computer system of claim 14, wherein the database of potential printers comprises:
a printer name and printer vendor name;
a library of printer drivers associated with the collection of printers; and
at least one printer property, comprising:
available paper sizes;
color printing;
duplex printing;
inventory of consumables;
a length of a printer queue;
a printer status;
a printer error condition;
cost per print for commercial providers;
ability to fax and scan;
ability to staple;
whether the printer is in a secured area;
an association of a printer to a network; and
printer performance; and
a library of printer drivers associated with the database of printers.

21. The method of claim 1, further comprising one or more requestor-defined printer profiles including keywords and options for each frequently used printers.

22. The computer program product of claim 7, further comprising one or more requestor-defined printer profiles including keywords and options for each frequently used printers.

23. The computer system of claim 14, further comprising one or more requestor-defined printer profiles including keywords and options for each frequently used printers.
